(19) United States
(12) Patent Application Publication
(10) Pub. No.: US 2002/0133332 A1
(43) Pub. Date: Sep. 19, 2002

(54) Phonetic feature based speech recognition apparatus and method

(76) Inventors: Linkai Bu, Tainan (TW); Tzi-Dar Chiueh, Taipei (TW)

Correspondence Address: BAKER & McKENZIE, 12th Floor, 101 West Broadway, San Diego, CA, 92101, US

(21) Appl. No.: 09/904,222

(22) Filed: Jul. 12, 2001

(30) Foreign Application Priority Data
Jul. 13, 2000 (TW) 89114003

(51) Int. Cl. G10L 19/14

(52) U.S. Cl. 704/205

(57) ABSTRACT

An apparatus and method for accurate speech recognition of an input speech spectrum vector in the Mandarin Chinese language comprising selecting a set of nine stationary Mandarin vowels for use as phonetic feature reference vowels, calculating projection and relative projection similarities of the input vector on the nine stationary Mandarin reference vowels, selecting from among said nine stationary Mandarin vowels a set of high projection similarity vowels, selecting from said set of high projection similarity vowels, the stationary Mandarin vowel having the highest relative projection similarity with the input vector, and selecting a vowel from said nine stationary Mandarin vowels responsive to a projection similarity measure if said set of high projection similarity vowels is null.

### FIELD OF THE INVENTION

This invention relates generally to automatic speech recognition systems and more particularly to a vowel vector projection similarity system and method to generate a set of phonetic features.

### BACKGROUND OF THE INVENTION

The Mandarin Chinese language embodies tens of thousands of individual characters each pronounced as a monosyllable, thereby providing a unique basis for ASR systems. However, Mandarin (and indeed the other dialects of Chinese) is a tonal language with each word syllable being uttered as one of four lexical tones or one natural tone. There are 408 base syllables and with tonal variation considered, a total of 1345 different tonal syllables. Thus, the number of unique characters is about ten times the number of pronunciations, engendering numerous homonyms. Each of the base syllables comprises a consonant (“INITIAL”) phoneme (21 in all) and a vowel (“FINAL”) phoneme (37 in all). Conventional ASR systems first detect the consonant phoneme, vowel phoneme and tone using different processing techniques. Then, to enhance recognition accuracy, a set of syllable candidates of higher probability is selected, and the candidates are checked against context for final selection. It is known in the art that most speech recognition systems rely primarily on vowel recognition as vowels have been found to be more distinct than consonants. Thus accurate vowel recognition is paramount to accurate speech recognition.

### SUMMARY OF THE INVENTION

An apparatus and method for accurate speech recognition of an input speech spectrum vector in the Mandarin Chinese language comprising selecting a set of nine stationary Mandarin vowels for use as phonetic feature reference vowels, calculating projection and relative projection similarities of the input vector on the nine stationary Mandarin vowels, selecting from among said nine stationary Mandarin vowels a set of high projection similarity vowels, selecting from said set of high projection similarity vowels, the stationary Mandarin vowel having the highest relative projection similarity with the input vector, and selecting a vowel from said nine stationary Mandarin vowels responsive to a projection similarity measure if said set of high projection similarity vowels is null.

### BRIEF DESCRIPTION OF THE DRAWINGS

FIG. 1 is a spectrogram of a stationary vowel “i” and a non-stationary vowel “ai”.

FIG. 2 is a spectrogram of, and the mel-scale frequency representation of, the nonstationary vowel “ai”.

FIG. 3(a) shows projection similarity as proportional to the projection of an input vector x along the direction of a reference vector c^{(k)}; 3(b) shows spectrally similar reference vowels, “i” and “iu”, where the projection similarities of the input vector on those similar reference vowels will all be large

FIG. 4 is a vector diagram depicting relative projection similarity for two-dimensional vectors.

FIG. 5 is a plot of the phonetic feature profile of the Mandarin vowel “ai” showing the transitions among the reference vowels according to the present invention.

FIG. 6(a) shows the projection similarity to a⁽⁸⁾ (the vertical axis) and to a⁽⁶⁾ (the horizontal axis) of the vowel “i” (dark dots) and the vowel “iu” (light dots).

FIG. 6(b) a comparison of the discernibility of projection similarity (without relative projection similarity) and the present invention's phonetic feature scheme for the reference spectra of the same vowels.

FIG. 7 is a graph of the “iu” phonetic feature versus the “i” phonetic feature with as a parameter having larger value with increasing grey scale according to the present invention.

### DETAILED DESCRIPTION OF THE INVENTION

Automatic speech recognition systems sample points for a discrete Fourier transform calculation or filter bank, or other means of determination of the amplitudes of the component waves of speech signal. For example, the parameterization of speech waveforms generated by a microphone is based upon the fact that any wave can be represented by a combination of simple sine and cosine waves; the combination of waves being given most elegantly by the Inverse Fourier Transform:

$$g ( t ) = {\int }_{- ∞}^{∞} G ( t ) {ⅇ}^{ⅈ2 π f t} ⅆ f$$

where the Fourier Coefficients are given by the Fourier Transform:

$$G ( t ) = {\int }_{- ∞}^{∞} g ( t ) {ⅇ}^{- ⅈ2 π f t} ⅆ t .$$

which gives the relative strengths of the components (amplitudes) of the wave at a frequency f, the spectrum of the wave in frequency space. Since a vector also has components which can be represented by sine and cosine functions, a speech signal can also be described by a spectrum vector. For actual calculations, the discrete Fourier transform is used:

$$G ( \frac{n}{τ N} ) = {\sum }_{k = 0}^{N - 1} [ τ \cdot g ( k τ ) {ⅇ}^{- i2π k \frac{n}{N}} ]$$

where k is the placing order of each sample value taken, is the interval between values read, and N is the total number of values read (the sample size). Computational efficiency is achieved by utilizing the fast Fourier transform (FFT) which performs the discrete Fourier transform calculations using a series of shortcuts based on the circularity of trigonometric functions.

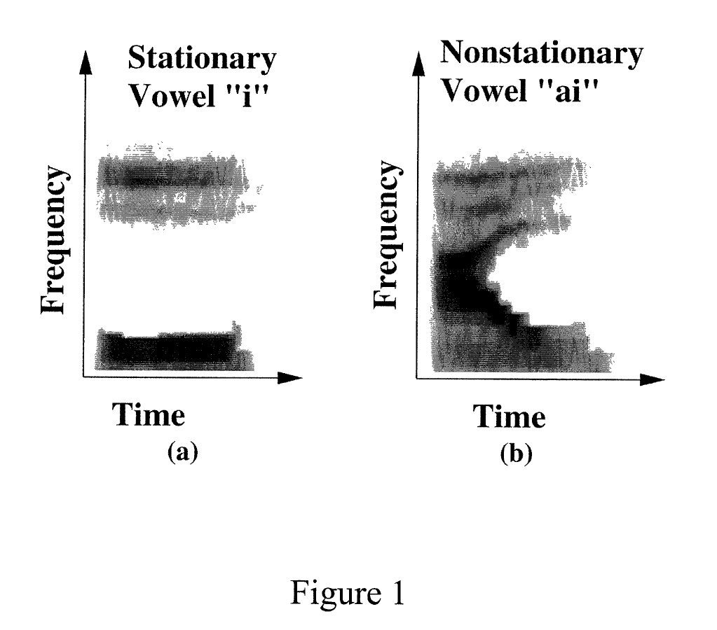

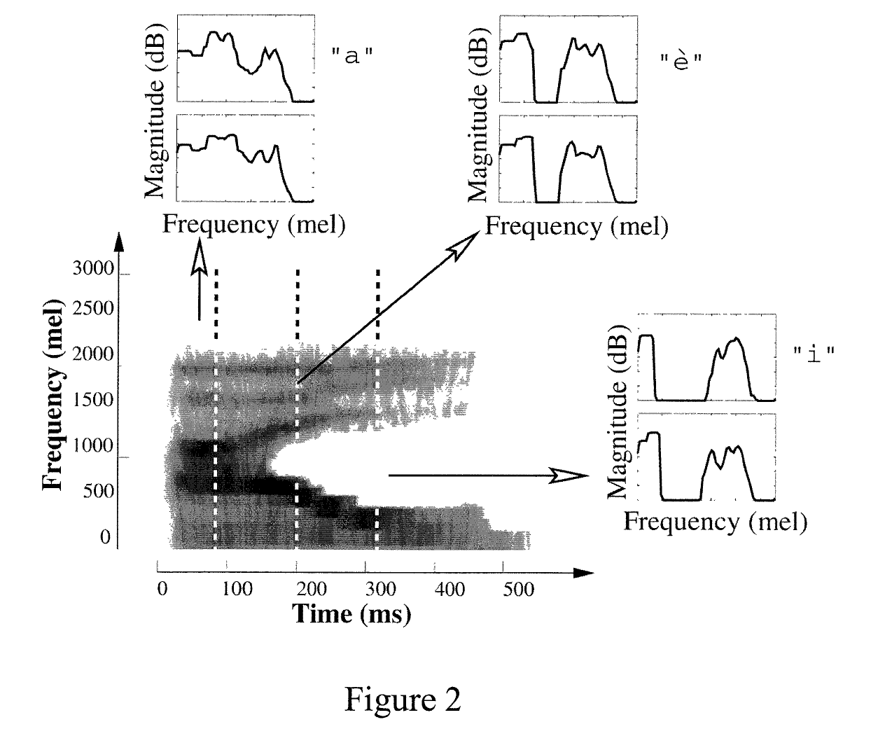

When humans speak, air is pushed out from the lungs to excite the vocal cord. The vocal tract then shapes the pressure wave according to what sounds are desired to be made. For some vowels, the vocal tract shape remains unchanged throughout the articulation, so the spectral shape is stationary for a short time. For other vowels, articulation begins with a vocal tract shape, which gradually changes, and then settles down to another shape. For the stationary vowels, spectral shape determines phoneme discrimination and those shapes are used as reference spectra in phonetic feature mapping. Non-stationary vowels, however, typically have two or three reference vowel segments and transitions between these vowels. FIG. 1 is a spectrogram of a stationary vowel “i” and a non-stationary vowel “ai” illustrating the differences. FIG. 2 is a spectrogram of, and the mel-scale frequency representation of, the nonstationary vowel “ai” showing the initial phase having a spectrum similar to vowel “a”, a shift to a spectrum similar to the vowel “e”, and finally settling down to a spectrum similar to the vowel “i”. A mel-scale adjustment translates physical Hertz frequency to a perceptual frequency scale and is used to describe human subjective pitch sensation In mel-scale, the low frequency spectral band is more pronounced than the high frequency spectral band; the relationship between Hertz- (or frequency) scale and mel-scale being given by:

mel=2595×log(1 +f/700)

where f is the signal frequency. The preferred embodiment of the present invention utilizes nine stationary vowels to serve as reference vowels to form the basis of all 37 Mandarin vowels. Table 1 shows the 37 Mandarin vowel phonemes and the nine reference phonemes.

TABLE 1

THE 37 MANDARIN VOWEL PHONEMES
a, o, e, ai, è, ei, au, ou, an, en,
ang, eng, i, u, iu, ia, ie, iau, iou, iai,
ian, in, iang, ing, ua, uo, uai, uei, uan, uen,
uang, ueng, iue, iuan, iun, iong, el
NINE REFERENCE MANDARIN VOWEL PHONEMES
a, o, e, è, eng, i, u, iu, el

The spectra of the nine reference vowels are represented by c⁽ⁱ⁾, where i=1, 2, . . . , 9 and each is a 64-dimensional vector for this case (or wave component in an inverse Fourier transform) computed by averaging all frames of a particular reference vowel in a training set.

The present invention utilizes a phonetic feature mapping generating nine features from a 64-dimensional spectrum vector. First, the present invention selects nine reference vectors from all the vowel phonemes. Next, the phonetic feature mapping computes the projection similarities of an input spectrum to the nine reference spectrum vectors, then computes another set of 72 relative similarities between the input spectrum and 72 pairs of reference spectrum vectors. Then, also based on the reference vectors, the mapping computes another set of 72 relative similarities of the input spectrum. The final set of nine phonetic features is achieved by combining these similarities. Unlike conventional classification schemes that categorize the input spectrum into one of the reference spectra, the present invention quantitatively gauges the shape of the input spectrum (also the shape of the vocal tract) against the nine reference spectra. The present invention's phonetic feature mapping achieves feature extraction (or dimensionality reduction) through similarity measures. The preferred embodiment of the present invention utilizes projection-based similarity measures of two types: projection similarity and relative projection similarity.

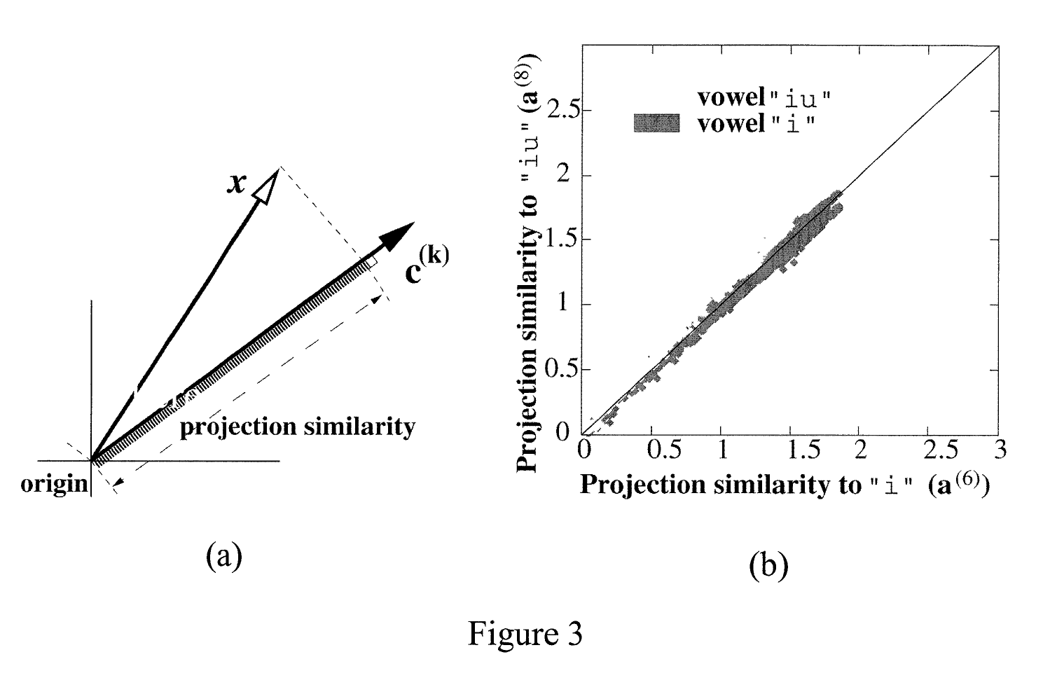

FIG. 3(a) shows projection similarity as proportional to the projection of an input vector x along the direction of a reference vector c^{(k)} with predetermined weighting, given by:

$${a}^{( k )} = \sum {w}_{i}^{( k )} \cdot {x}_{i} \cdot \frac{{c}_{i}^{( k )}}{‖ {c}^{( k )} ‖}$$

where k =1, . . . , 9 and

$${c}^{( k )} = ( {\sum }_{i = 1}^{64} {( {c}_{i}^{( k )} )}^{2}$$

and the weighting factor is given by

$${w}_{i}^{( k )} = \frac{{c}_{i}^{( k )} / {σ}_{i}^{( k )}}{{\sum }_{i = 1}^{64} {c}_{i}^{( k )} / {σ}_{i}^{( k )}}$$

where i=1, 2, . . . , 64 and k=1, 2, . . . , 9 and ᵢ^{(k)} is the standard deviation of dimension in the ensemble corresponding to the k^{th} reference vowel. The ᵢ^{(k)} in the weighting factor wᵢ^{(k)} serves as a constant that makes all dimensions in all nine reference vectors of the same variance. The cᵢ^{(k)} term in the weighting factor emphasizes the spectral components having larger magnitudes. The set of weights that correspond to each reference vector is normalized.

For many cases, the projection similarities described above are sufficient for accurate speech recognition. But FIG. 3(b) shows a case of spectrally similar reference vowels, “i” and “iu”, where the projection similarities of the input vector on those similar reference vowels will all be large and a speech input will be spectrally close to the similar phonemes, thereby requiring more differentiation to achieve accurate speech recognition.

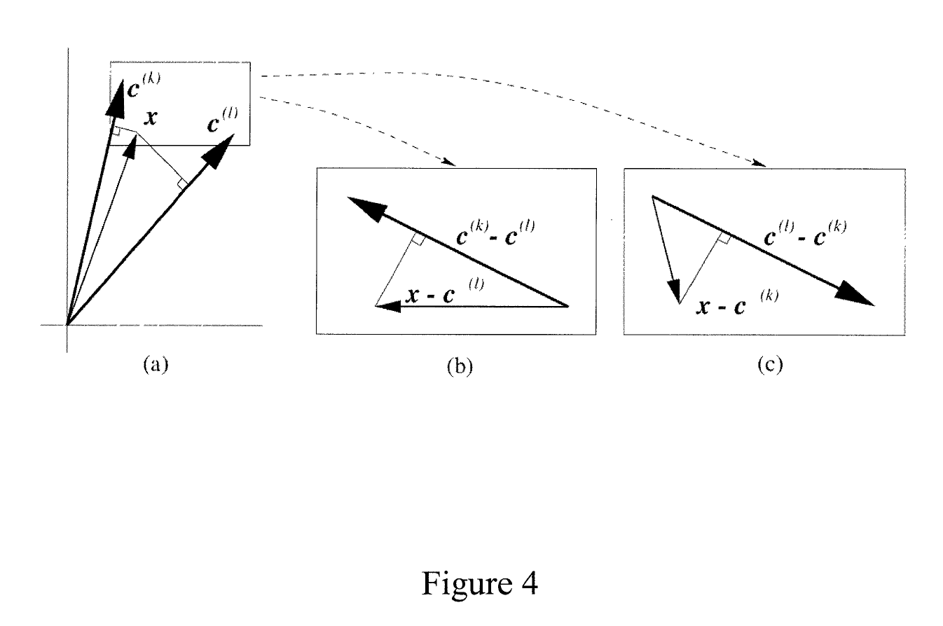

Another embodiment of the present invention utilizes “relative projection similarity” which extracts only the critical spectral components, thereby achieving better differentiation. For ease of illustration FIG. 4 is a vector diagram depicting relative projection similarity for two-dimensional vectors. Of course, all multi-dimensional vectors are within the contemplation of the present invention. An input vector x that is close to two similar reference vectors c^{(k)} and c^{(l)}, being somewhat closer to c^{(k)}, but the difference in projections is not large, as shown in FIG. 4(a). The difference between c^{(k)} and c^{(l)} given by c^{(k)}−c^{(l)} is critical for the categorization of the input speech vector x. FIGS. 4(b) and 4(c) show that the projection of x−c^{(l)} on c^{(k)}−c^{(l)} is larger than the projection of x-c^{(k)} on c^{(l)}−c^{(k)} and their difference is more pronounced than the difference between the projections of x alone on c^{(k)} and on c^{(l)}. Using this observation, the statistically-weighted projection of the input vector x on c(k) with respect to c^{(l)} is:

$${q}^{( k , 1 )} = {\sum }_{i = 1}^{64} {v}_{i}^{( k , l )} \cdot ( {x}_{i} - {c}_{i}^{( l )} ) \cdot \frac{( {c}_{i}^{( k )} - {c}_{i}^{( l )} )}{‖ {c}^{( k )} - {c}^{( l )} ‖}$$

where k,1=1, . . . , 9,1 k, and

$$‖ {c}^{( k )} - {c}^{( l )} ‖ = \sqrt{{\sum }_{i = 1}^{64} {( {c}_{i}^{( k )} - {c}_{i}^{( l )} )}^{2}} .$$

The normalized weighting factor is given by

$${v}_{i}^{( k , l )} = \frac{\vert {c}_{i}^{( k )} - {c}_{i}^{( l )} \vert / \sqrt{{( {σ}_{i}^{( k )} )}^{2} + {( {σ}_{i}^{( l )} )}^{2}}}{{\sum }_{i = 1}^{64} \vert {c}_{i}^{( k )} - {c}_{i}^{( l )} \vert / \sqrt{{( {σ}_{i}^{( k )} )}^{2} + {( {σ}_{i}^{( l )} )}^{2}}}$$

where i=1, . . . , 64; k, 1=1, . . . , 9, 1 k. The weighting factors serve to emphasize those components of the two reference vectors which have large differences as well as to make variances in all dimensions the same. In the cases where q^{(k,l)} is negative, in order to control the dynamic range and maintain the cues for discriminating the input vector, negative q^{(k,l)} is set to a small positive value and positive q^{(k,l)} does not change (unipolar ramping function). The relative projection similarity of x on c^{(k)} with respect to c^{(l)} is defined as

$${r}^{( k , l )} = \frac{{q}^{( k , l )}}{{q}^{( k , l )} + {q}^{( l , k )}}$$

where k,1=1, . . . , 9, 1 k. Thus there is a total of 8×9=72 relative projection similarities which, together with the nine projection similarities, defines the phonetic features of the preferred embodiment of the present invention.

In one embodiment of the present invention, the integration of the projection similarities and relative projection similarities to recognize speech utilizes a hierarchical classification wherein the projection similarities determine a first coarse classification by selecting candidates having large values for the projection of x on c^{(k)}; that is, large values for a^{(k)}. The candidates are further screened using pairwise relative projection similarities. However, if the first coarse classification is not tuned properly, good candidates may not be selected.

In the preferred embodiment of the present invention, projection similarity and relative projection similarity are integrated by phonetic feature mapping utilizing the scheme: (a) relative projection similarity should be utilized for any two reference vectors having large projection similarities, and (b) otherwise, projection similarity can be used alone. This will not only produce more accurate speech recognition, but is also computationally efficient. The phonetic feature is defined as

$${p}^{( k )} = \frac{1}{λ} {a}^{( k )} + \frac{1}{λ} {\sum }_{l = 1 , l \neq k}^{9} ( {r}^{( k , l )} {p}^{( l )} - {r}^{( l , k )} {p}^{( k )} )$$

where k=1, 2, . . . , 9 and is a scaling factor to control the degree of cross coupling, or lateral inhibition. The solution to the above equation for two reference vectors (for simplicity of illustration) is given by

$$\frac{{p}^{( k )}}{{p}^{( l )}} = \frac{λ {a}^{( k )} + ( {a}^{( k )} + {a}^{( l )} ) {r}^{( k , l )}}{λ {a}^{( l )} + ( {a}^{( k )} + {a}^{( l )} ) {r}^{( l , k )}} .$$

For the case that both a^{(k)} and a^{(l)} are large and have comparable magnitudes, assuming that x is closer to c^{(k)} in the Euclidean norm sense, the distance between x and c^{(k)} is smaller, so r^{(k,l)} is larger than r^{(l,k)}. If is relatively small, then p^{(k)}/p^{(l)} is approximately r^{(k,l)}/r^{(l,k)}, which is determined by r^{(k,l)} and r^{(l,k)}, the relative projection similarities. For the case where only one of a^{(k)} and a^{(l)} is large, assuming that a^{(k)} is large, then r^{(k,l)} and r^{(l,k)} are close to one and zero respectively and

$${p}^{( k )} / {p}^{( l )} \approx \frac{( λ + 1 ) {a}^{( k )} + {a}^{( l )}}{λ {a}^{( l )}} ,$$

which is determined by a^{(k)} and a^{(l)}. For the third and last possible case, where both a^{(k)} and a^{(l)} are small,

p^{(k)}∝λa^{(k)}+(a^{(k)}+a^{(l)})r^{(k,l)}

and

p^{(l)}∝λa^{(l)}+(a^{(k)}+a^{(l)})r^{(l,k)}

Since both a^{(k)} and a^{(l)} are small, and r^{(k,l)} and r^{(l,k)} are less than one, thus p^{(k)} and p^{(l)} are also small and negligible. Defining

$${r}^{( k , k )} = λ + {\sum }_{l = l , l \neq k}^{9} {r}^{( l , k )}$$

where k=1, 2, . . . , 9, then the equation for p^{(k)} above can be written in matrix form as

$$[ \begin{matrix}- {r}^{( 1 , 1 )} & {r}^{( 1 , 2 )} & {r}^{( 1 , 3 )} & … & {r}^{( 1 , 9 )} \\ {r}^{( 2 , 1 )} & - {r}^{( 2 , 2 )} & {r}^{( 2 , 3 )} & … & {r}^{( 2 , 9 )} \\ {r}^{( 3 , 1 )} & {r}^{( 3 , 2 )} & - {r}^{( 3 , 3 )} & … & {r}^{( 3 , 9 )} \\ ⋮ & ⋮ & ⋮ & ⋰ & ⋮ \\ {r}^{( 9 , 1 )} & {r}^{( 9 , 2 )} & {r}^{( 9 , 3 )} & … & - {r}^{( 9 , 9 )}\end{matrix} ] [ \begin{matrix}{p}^{( 1 )} \\ {p}^{( 2 )} \\ {p}^{( 3 )} \\ ⋮ \\ {p}^{( 9 )}\end{matrix} ] = [ \begin{matrix}- {a}^{( 1 )} \\ - {a}^{( 2 )} \\ - {a}^{( 3 )} \\ ⋮ \\ - {a}^{( 9 )}\end{matrix} ]$$

Phonetic features p^{(k)} for k=1, 2, . . . , 9 is solved by multiplying the inverse of the matrix above on both sides.

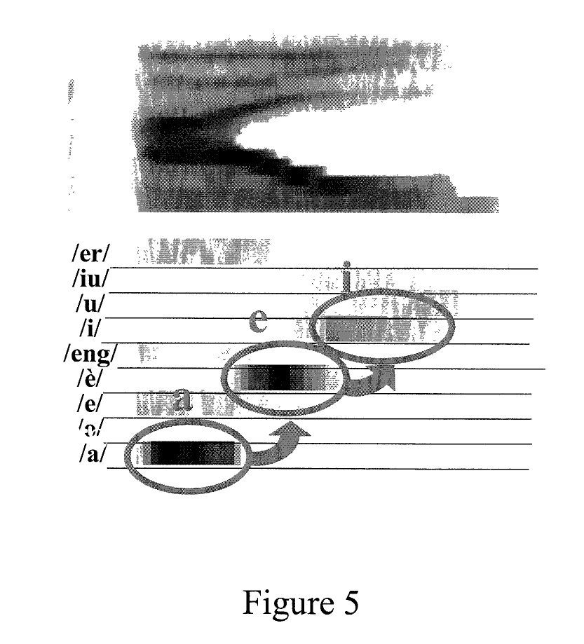

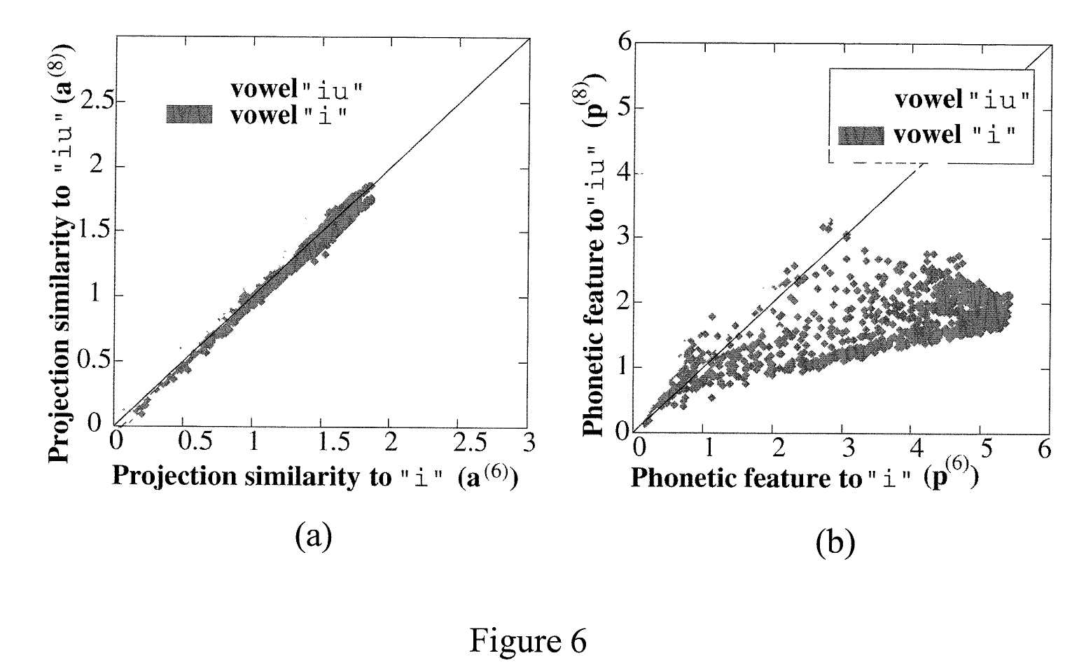

FIG. 5 is a plot of the phonetic feature profile of the Mandarin vowel “ai”; the largest phonetic feature in the beginning is “a”, then a transition to the vowel “e”, and finally “i” becomes the largest phonetic feature. After 450 ms, the phonetic feature “u” becomes visible, albeit relatively short and not conspicuous. The present invention through break-up into basic nine vowels achieves a significant discernibility. By utilizing relative projection similarities to enhance discernibility among similar reference vowels, even greater accuracy speech recognition is achieved. FIG. 6(a) shows the projection similarity to a⁽⁸⁾ (“iu”, the vertical axis) and to a⁽⁶⁾ (“i”, the horizontal axis) of the vowel “i” (dark dots) and the vowel “iu” (light dots). For projection similarity alone, the discernibility is not great as the different vowels are very close together as shown in FIG. 6(a). However, when the phonetic feature scheme of the present invention is utilized for “i” (p⁽⁶⁾, dark shading) and “iu” (p⁽⁸⁾, light shading), the discernibility is greatly enhanced as seen from the distinct separation of the vowels shown in FIG. 6(b).

Humans perceive speech through several hierarchical partial recognitions. The present invention encompasses partial recognition because, as described immediately above, a vowel is broken up into segments of the nine reference vowels. Further, when listening, humans ignore much irrelevant information. The nine reference vowels of the present invention serve to discard much irrelevant information. Thus, the present invention embodies characteristics of human speech perception to achieve greater speech recognition.

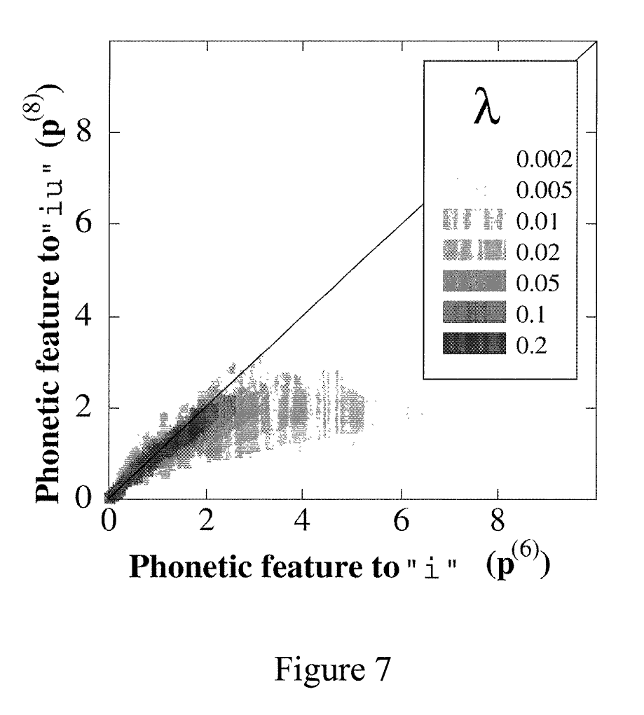

The discernibility of a phonetic feature p^{(k)} in the present invention is controlled by the value given to the scaling factor. As seen in the equation for p^{(k)} above, if is large, the sum of the relative projection similarities r^{(k,l)} is overwhelmed by. FIG. 7 is a graph of the effect of the phonetic feature scheme of the present invention utilized for “i” (p⁽⁶⁾, dark shading) and “iu” (p⁽⁸⁾, light shading), the discernibility is greatly enhanced as a function of (a parameter having larger value with increasing grey scale). Smaller values of scatter the distribution away from the diagonal (which represents non-discernibility), making the two vowels more discernible thereby improving recognition accuracy. However, a too small value for will result in a dispersion that is difficult to model by a multi-dimensional Gaussian function, resulting in poor recognition accuracy. Thus the present invention advantageously utilizes the value of the scaling factor to optimize discernibility while limiting dispersion.

While the above is a full description of the specific embodiments, various modifications, alternative constructions and equivalents may be used. For example, although the present invention is described with reference to the Mandarin Chinese language, the concepts and implementations are suitable for any language having syllables. Further, any . . . technique can be advantageously utilized. Therefore, the above description and illustrations should not be taken as limiting the scope of the present invention which is defined by the appended claims.

What is claimed is:

1. A method for speech recognition of an input vector in the Mandarin Chinese language comprising the step of utilizing a set of stationary Mandarin vowels as phonetic feature reference vowels.

2. The method of claim 1 wherein said set of stationary Mandarin vowels has nine members.

3. The method of claim 2 further comprising the step of calculating projection similarities of the input vector on said set of stationary Mandarin vowels;

4. The method of claim 3 further comprising the step of selecting a candidate vowel from said set of stationary Mandarin vowels responsive to the highest value of said projection similarity calculation.

5. The method of claim 2 further comprising the step of calculating relative projection similarities of the input vector on said set of stationary Mandarin vowels. The phonetic feature mapping is based on nine reference vectors.

6. The method of claim 5 further comprising the step of selecting a candidate vowel from said set of stationary Mandarin vowels responsive to the highest value of said relative projection similarity calculation.

7. A method for speech recognition of an input vector in the Mandarin Chinese language comprising the steps of:
(a) selecting nine stationary reference Mandarin vowels for use as phonetic feature reference vowels;
(b) calculating projection similarities of the input vector on said nine stationary Mandarin vowels;
(c) calculating relative projection similarities of the input vector on said nine stationary Mandarin vowels;
(d) selecting from among said nine stationary Mandarin vowels a set of high projection similarity vowels;
(e) selecting from said set of high projection similarity vowels, the stationary Mandarin vowel having the highest relative projection similarity with the input vector; and
(f) selecting a vowel from said nine stationary reference Mandarin vowels responsive to the highest projection similarity calculation if said set of high projection similarity vowels is null.

8. The method of claim 7 further comprising the step of utilizing a scaling factor to control the degree of relative projection cross coupling, thereby increasing the discernibility of a phonetic feature.

9. A phonetic feature mapper for mapping an input speech spectrum vector comprising: storage means for storing a set of nine stationary Mandarin reference spectrum vectors; processing means, coupled to said storage means, for computing projection similarities of the input spectrum vector on said nine stationary Mandarin reference spectrum vectors; and selection means, coupled to said processing means, for selecting at least one of said nine stationary Mandarin reference spectrum vectors responsive to the highest projection similarity values computed by said processing means.

10. A phonetic feature mapper for mapping an input speech spectrum vector comprising:
storage means for storing a set of nine stationary Mandarin reference spectrum vectors;
processing means, coupled to said storage means, for computing relative projection similarities of the input spectrum vector on said nine stationary Mandarin reference vectors; and
selection means, coupled to said processing means, for selecting at least one of said nine stationary Mandarin reference spectrum vectors responsive to the highest relative projection similarity values computed by said processing means.

11. A phonetic feature mapper for mapping an input speech spectrum vector comprising:
storage means for storing a set of nine stationary Mandarin reference spectrum vectors;
processing means, coupled to said storage means, for computing projection similarities and relative projection similarities of the input spectrum vector on said nine stationary Mandarin reference vectors;
selection means, coupled to said processing means, for selecting at least one of the nine stationary Mandarin reference spectrum vectors responsive to the computation of the projection similarity and relative projection similarity values computed by said processing means.

12. The phonetic feature mapper of claim 11 wherein said processing means further utilizes a scaling factor to control the degree of relative projection cross coupling, thereby increasing the discernibility of a phonetic feature.
